(19) United States
(12) Patent Application Publication
(10) Pub. No.: US 2018/0373279 A1
(43) Pub. Date: Dec. 27, 2018

(54) TEMPERATURE CONTROL SYSTEMS

(71) Applicant: MERVIN WADE HOWENSTINE, TRINITY, TX (US)

(72) Inventor: MERVIN WADE HOWENSTINE, TRINITY, TX (US)

(21) Appl. No.: 16/019,481

(22) Filed: Jun. 26, 2018

Related U.S. Application Data
(60) Provisional application No. 62/525,159, filed on Jun. 26, 2017.

(51) Int. Cl. G05D 23/24; F25D 29/00; G05D 23/19

(52) U.S. Cl. CPC G05D 23/24; F25D 29/00; F25D 2700/12; F25B 2600/11; G05D 23/1919

(57) ABSTRACT

A temperature control system including an electrical relay system, a thermistor, a normally open/normally closed digital thermostat, a parallel-circuit, and a series-circuit, with each of the parallel-circuit and the series-circuit electrically coupled to a refrigeration system. The parallel-circuit is electrically coupled to a relay and a cooling system and the relay-coil is in electrical communication and controlled via the thermostat. Also, the thermostat is in electrical communication with the thermistor. The temperature control system is configured to operate both the parallel-circuit and the series-circuit simultaneously while the temperature is above a first-set-point, and temperature control system, via the relay assembly, and cuts current flow to the parallel-circuit when the temperature is at or below the second-set-point, configured to reduce a wattage supplied and therefore a speed of fan motors of the evaporative refrigeration system to conserve power usage.

### CROSS-REFERENCE TO RELATED APPLICATION(S)

The present application is related to and claims priority to U.S. Provisional Patent Application No. 62/525,159 filed Jun. 26, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of refrigeration of existing art and more specifically relates to refrigeration air controllers and directors.

### RELATED ART

Refrigeration is the process of removing heat and therefore cooling a space and/or articles. This is achieved by using a low-temperature reservoir to transfer heat to a high-temperature reservoir which dissipates the heat to an ambient environment. The work of heat transfer is generally achieved by mechanical means such as pumps. Refrigeration has many applications, such as food storage, agriculture, as well as many others.

Typical industrial and commercial refrigeration use a condenser to cool a fluid which is transferred to a system of cooling fins. The cooling fins are generally associated with one or more fans in which air is forced across the cooling fins to cool air to a desired predetermined temperature. Once the air is to the desired temperature, the system generally shuts off until the air exceeds the predetermined temperature. The fans are generally operated at one speed such that the fans are either fully on or fully off. This arrangement creates a large load at startup of the fans. Also, this arrangement uses a significant amount of power consumption as there is no low speed setting for the fans. Therefore, a suitable solution is desired.

U.S. Pub. No. 2008/0245085 to Sikander Jaffer relates to a cooling apparatus with evaporator. The described cooling apparatus with evaporator includes a cooling apparatus for objects such as convenience foods and beverages which has an enclosure and a vapor cycle refrigeration system. The refrigeration system includes a compressor, a condenser, a metering device and an evaporator, all connected in a circuit. Fans force air across the evaporator coils during operation of the compressor. When the compressor is ‘off’, or dormant, the evaporator fans are operated in a partial or reduced duty cycle in which the overall power draw and average power consumption is less than it would be if the evaporator fans were run continuously.

### SUMMARY OF THE INVENTION

In view of the foregoing disadvantages inherent in the known refrigeration air controllers' art, the present disclosure provides a novel temperature control system. The general purpose of the present disclosure, which will be described subsequently in greater detail, is to provide an efficient and effective temperature control system.

A temperature control system is disclosed herein. The temperature control system includes an electrical relay assembly, a thermistor, a normally open/normally closed digital thermostat, a parallel-circuit, and a series-circuit, with each of the parallel-circuit and the series-circuit electrically coupled to a cooling system; the refrigeration system preferably including three fan motors. The temperature control system is preferably coupled to a 120-volt alternating current power supply.

Preferably the thermistor is located on the exit-side of the cooling fins of the refrigeration system, and the thermistor is located vertically in the center of the cooling fins and substantially 1-inch horizontally from the bottom of the cooling fins of the refrigeration system.

Preferably, the electrical relay assembly includes a relay-coil and a relay with at least two poles, with the relay controllable via a relay-coil. Preferably, the thermistor is located in proximity to cooling fins of a refrigeration system, with the thermistor being ¼-inch in nominal size, with the thermistor located on the exit side of the cooling fins of the refrigeration system.

The parallel-circuit is preferably electrically coupled to the relay and the cooling system and the relay-coil is in electrical communication and controlled via the thermostat. Also, the thermostat is in electrical communication with the thermistor.

The thermistor and the thermostat control operation of a condenser and therefore turn on the condenser when the temperature is above a first-set-point. Also, the thermistor and the thermostat control operation of a condenser and therefore turn off the condenser when the temperature is at or below a second-set-point.

Further, the temperature control system is configured to operate both the parallel-circuit and the series-circuit simultaneously while the temperature is above the first-set-point, and temperature control system, via said relay assembly, and cuts current flow to the parallel-circuit when the temperature is at or below the second-set-point, configured to reduce a wattage supplied and therefore a speed of fan motors of the refrigeration system to conserve and reduce power consumption/usage.

According to another embodiment, method of using a temperature control system is also disclosed herein. The method of using a temperature control system includes a first step, providing a refrigeration system; a second step, providing a temperature control system; a third step, placing a thermistor of the temperature control system in proximity to cooling fins of the refrigeration system; a fourth step, providing an electrical power supply in both a series arrangement and a parallel arrangement to fan motors of the evaporative refrigeration system when the thermistor reads a first temperature; and a fifth step, commencing providing electrical power to the parallel arrangement to the fan motors of the evaporative refrigeration system when the thermistor reads a second temperature.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a temperature control system, constructed and operative according to the teachings of the present disclosure.

FIG. 1 is a perspective view of the temperature control system during an ‘in-use’ condition, according to an embodiment of the disclosure.

FIG. 2 is an electrical diagram of the temperature control system of FIG. 1, according to an embodiment of the present disclosure.

FIG. 3 is an electrical diagram of the temperature control system of FIG. 1, according to an embodiment of the present disclosure.

FIG. 4 is an electrical diagram of the temperature control system of FIG. 1, according to an embodiment of the present disclosure.

FIG. 5 is a flow diagram illustrating a method of using the temperature control system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a refrigeration air controllers and directors and more particularly to a temperature control system and method as used to improve the power consumption efficiency of a refrigeration unit by providing both a parallel and series circuit to fan motors of a refrigeration unit.

Generally, the temperature control system offers a unique opportunity for the application of a relay to provide both a series and parallel circuit in conjunction with a dual input power supply. The series circuit may include electrical input at lower power consumption to three or more fan motors when the relay is in a deactivated mode, and the parallel circuit may provide full power delivered when the relay in a closed mode to the fan motors.

In general, the temperature control system includes circuitry to provide a full-power mode to the fans in parallel, such that the fans and cooling system components operate at full-power while the components of the cooling system operate. Additional circuitry includes a low-power mode such that the fans operate at a lower power condition such that the power draw of the entire system is reduced therefore reducing cost via a series circuit.

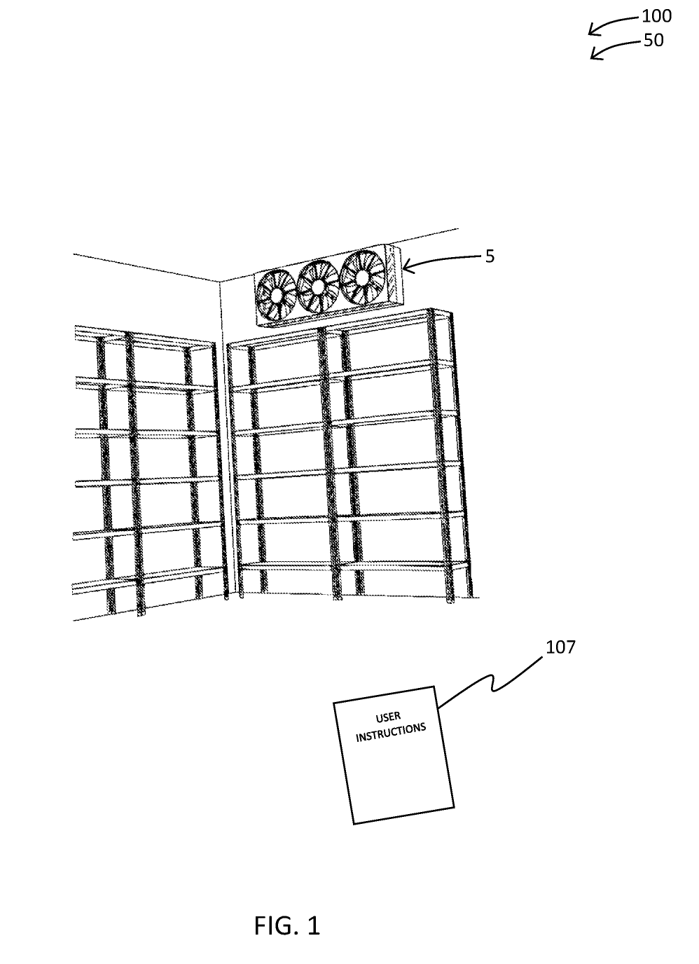

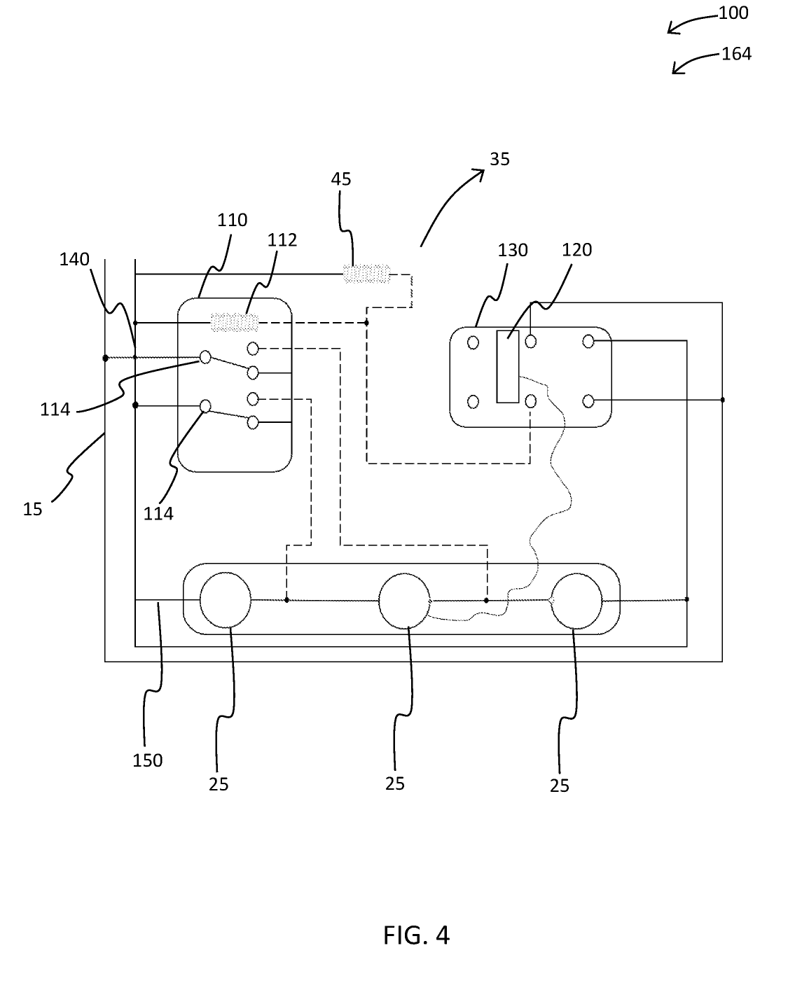

Referring now more specifically to the drawings by numerals of reference, there is shown in FIGS. 1-4, various views of temperature control system 100. FIG. 1 shows during an ‘in-use’ condition 50, according to an embodiment of the present disclosure. Here, temperature control system 100 may be beneficial for use by a user to reduce power consumption of a cooling system 5 by allowing cooling fans of the refrigeration 5 system to operate at a low speed and lower power consumption. As illustrated in FIGS. 1-4, temperature control system 100 may include electrical relay assembly 110, thermistor 120, normally open/normally closed digital thermostat 130, parallel-circuit 140, and series-circuit 150. Upon reading this specification, it should be appreciated that, under appropriate circumstances, considering such issues as user preferences, design preference, structural requirements, marketing preferences, cost, available materials, technological advances, etc., other electrical and mechanical arrangements such as, for example, circuitry and electrical components, etc., may be sufficient.

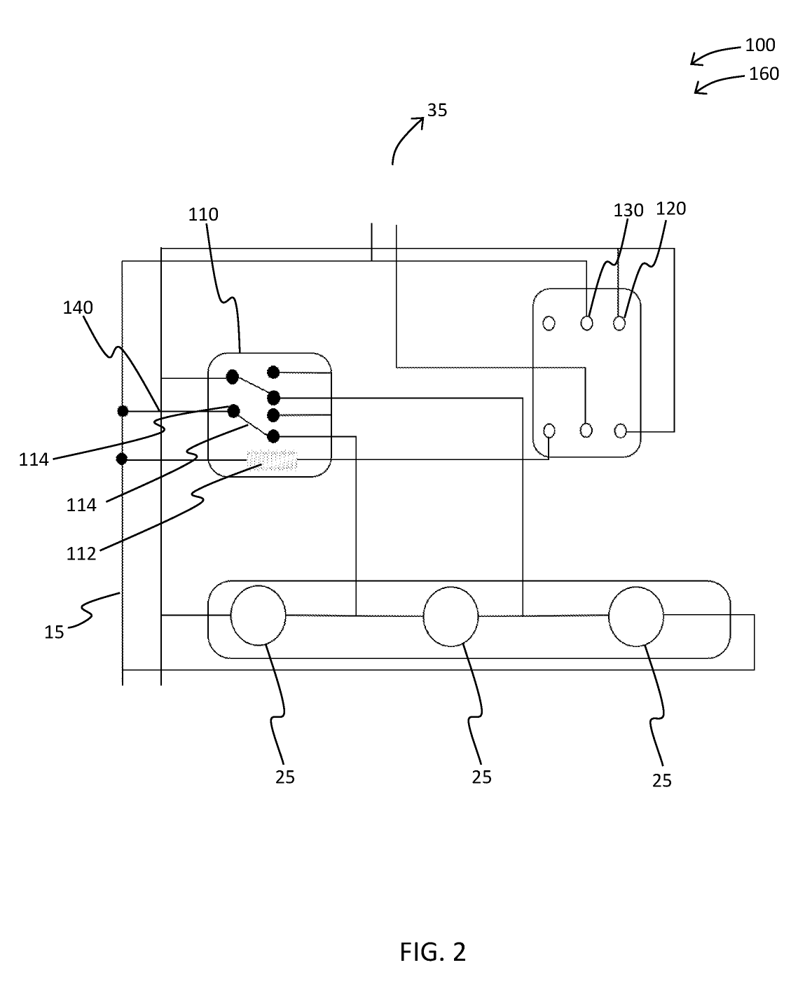

As shown in FIGS. 2-4, parallel-circuit 140 may be electrically coupled to relay 114 (relay including at least two poles) and cooling system 5. Similarly, series-circuit 150 may be electrically coupled to cooling system 5. Temperature control system 100 may be electrically coupled to alternating current power supply 15, and relay-coil 112 may be in electrical communication and controlled via thermostat 130. Thermostat 130 may be in electrical communication with thermistor 120.

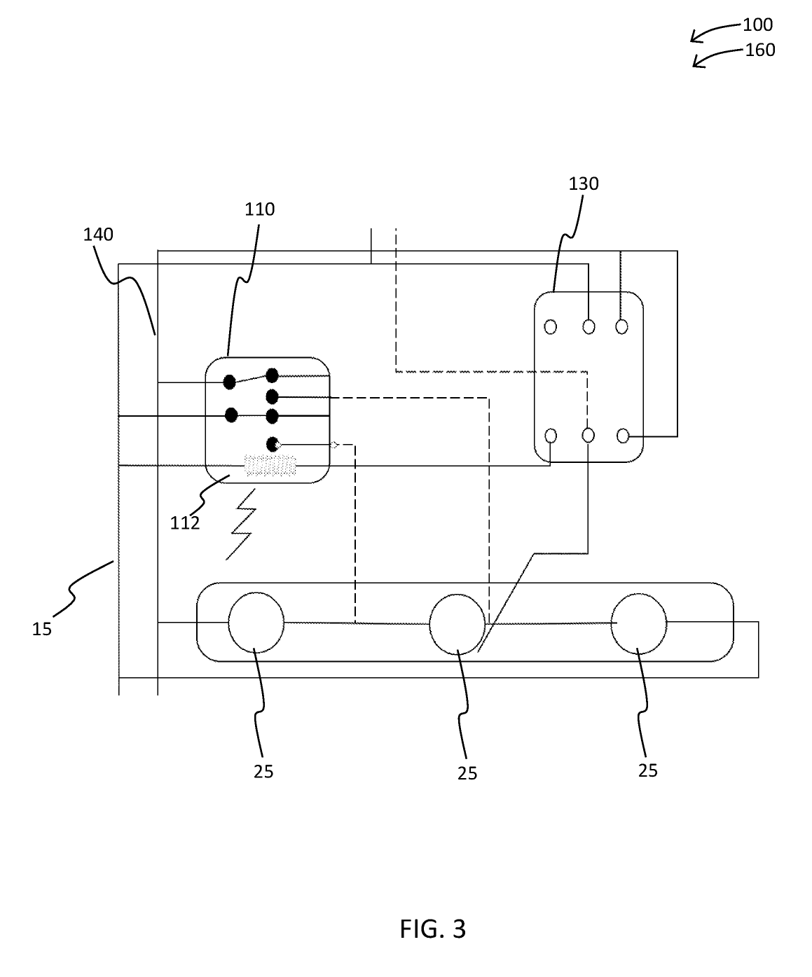

Electrical relay assembly 110 may include relay-coil 112 and relay 114, where relay 114 may be controllable via relay-coil 112. Relay 114 may operate in normally closed position 160 (FIG. 2) when thermistor 120 reads a temperature above a first-set-point. Also, relay 114 may operate in open position 164 (FIG. 3) when thermistor 120 reads a temperature at or below a second-set-point. Depending upon preferences and specific conditions or locations, set point may include temperatures registered in Fahrenheit, Celsius, and/or Kelvin.

As such, temperature control system 100 may be configured to operate both parallel-circuit 140 and series-circuit 150 while the temperature is above the first-set-point (as shown in FIG. 2). Also, temperature control system 100, via relay assembly 110, may cut current flow to parallel-circuit 140 (FIG. 3) when the temperature read by thermistor 120 is at or below the second-set-point, configured to reduce a wattage supplied (and therefore a speed of fan motors) of evaporative refrigeration system 5, reducing power consumption.

Thermistor 120 and thermostat 130 (in communication and conjunction) may control operation of a condenser of cooling system 5, and therefore turn off the condenser when the temperature is at or below the second-set-point. Similarly, thermistor 120 and thermostat 130 (similarly in communication and conjunction) may control operation of the condenser and therefore turn on the condenser when the temperature is above the first-set-point.

The temperature difference between the first-set-point and the second-set-point may be less than 10-degrees Fahrenheit, in embodiments. Also, the temperature difference between the first-set-point and the second-set-point may greater than 10-degrees Fahrenheit, in embodiments. The first set point may be 34-degree Fahrenheit and second set-point may be 23-degrees Fahrenheit, in some embodiments. Other embodiments may include different set point differentials as well as other temperatures. Temperature differentials and/or first-set point and second-set point may be read via thermistor 120 in alternate temperature scales that may be translated into alternate units of measure of temperature, in embodiments.

Thermistor 120 may be located in proximity to the cooling fins of evaporative refrigeration system 5. Thermistor 120 may be ¼-inch in nominal size, in embodiments. Other embodiments may include thermistor 120 in other sizes, depending upon specific applications. Thermistor 120 may be located on the exit-side of cooling fins of evaporative refrigeration system 5, as well as being is located vertically in the center of the cooling fins and substantially 1-inch horizontally from a bottom of the cooling fins of evaporative refrigeration system 5. Thermistor 120 may also be located on the intake-side of the cooling fins, in some embodiments. Evaporative refrigeration system 100 may include three fan motors; evaporative refrigeration system 100 may include more than three fan motors. Also, alternating current power supply 15 may include different voltages, in embodiments. For example, alternating current power supply 15 may include 120 volts, 240 colts, or 480 volts, dependent upon specific applications. Those with ordinary skill in the art will now appreciate that upon reading this specification and by their understanding the art of refrigeration and electrical construction as described herein, methods of use and assembly of electrical components will be understood by those knowledgeable in such art.

According to one embodiment, temperature control system 100 may be arranged as a kit 105. In particular, temperature control system 100 may further include a set of instructions 107. The instructions 107 may detail functional relationships in relation to the structure of the temperature control system 100 such that the temperature control system 100 can be used, maintained, or the like, in a preferred manner.

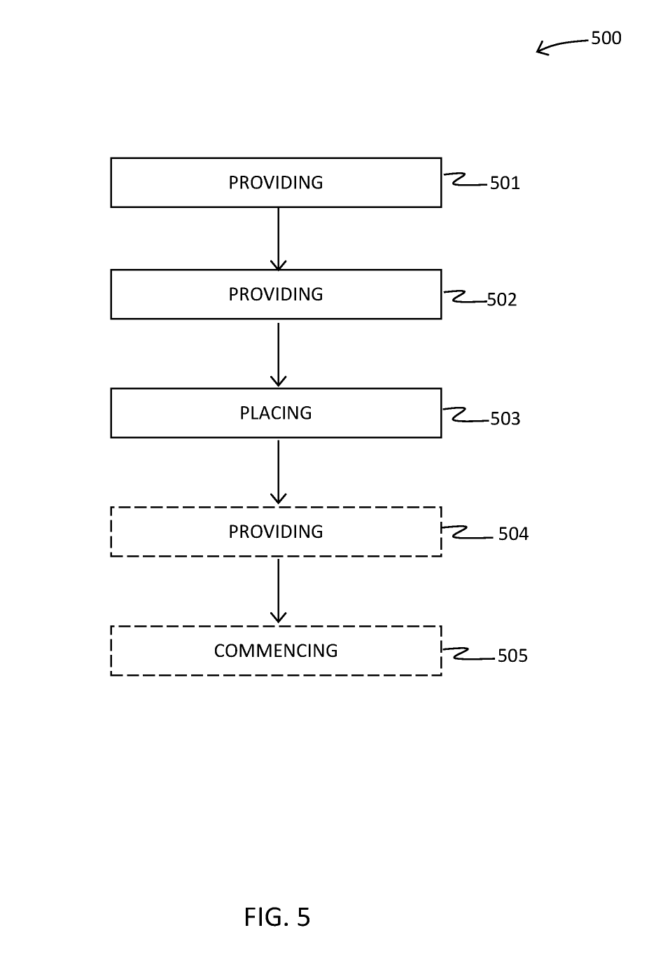

FIG. 5 is a flow diagram illustrating a method of using 500 a temperature control system 100, according to an embodiment of the present disclosure. In particular method of using 500 a temperature control system 100 may include one or more components or features of temperature control system 100 as described above. As illustrated, method of using 500 a temperature control system 100 may include the steps of: step one 501, providing a refrigeration system 5; step two 502, providing temperature control system 100; step three 503, placing thermistor 120 of temperature control system 100 in proximity to cooling fins of refrigeration system 5; step four 504, providing electrical power supply 15 in both a series arrangement and a parallel arrangement to fan motors 25 of refrigeration system 5 when thermistor 120 reads a first temperature; and step five 505, commencing providing electrical power to the parallel arrangement to fan motors 25 of refrigeration system 5 when thermistor 120 reads a second temperature.

It should be noted that step four 504, and step five 505 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A temperature control system, the system comprising:
an electrical relay assembly, said electrical relay assembly including a relay-coil and a relay including at least two poles, said relay controllable via said relay-coil;
a thermistor located in proximity to cooling fins of a refrigeration system;
a normally open/normally closed digital thermostat;
a parallel-circuit electrically coupled to said relay and said evaporative cooling system;
a series-circuit electrically coupled to said evaporative cooling system;
wherein said system is electrically coupled to an alternating current power supply;
wherein said relay-coil is in electrical communication and controlled via said thermostat;
wherein said thermostat is in electrical communication with said thermistor;
wherein said relay operates in a normally closed position when said thermistor reads a temperature above a first-set-point;
wherein said relay operates in an open position when said thermistor reads a temperature at or below a second-set-point;
wherein said temperature control system is configured to operate both said parallel-circuit and said series-circuit while said temperature is above said first-set-point; and
wherein said temperature control system, via said relay assembly, cuts current flow to said parallel-circuit when said temperature is at or below said second-set-point configured to reduce a wattage supplied and therefore a speed of fan motors of said refrigeration system.

2. The temperature control system of claim 1, wherein said thermistor is ¼-inch in nominal size.

3. The temperature control system of claim 1, wherein said thermistor is located on the exit-side of said cooling fins of said refrigeration system.

4. The temperature control system of claim 1, wherein said thermistor is located vertically in the center of said cooling fins and substantially 1-inch horizontally from a bottom of said cooling fins of said refrigeration system.

5. The temperature control system of claim 1, wherein said refrigeration system includes three fan motors.

6. The temperature control system of claim 1, wherein said refrigeration system includes more than three fan motors.

7. The temperature control system of claim 1, wherein said thermistor and said thermostat control operation of a condenser and therefore turn off said condenser when said temperature is at or below said second-set-point.

8. The temperature control system of claim 1, wherein said thermistor and said thermostat control operation of a condenser and therefore turn on said condenser when said temperature is above said first-set-point.

9. The temperature control system of claim 1, wherein said thermistor is located on the intake-side of said cooling fins of said refrigeration system.

10. The temperature control system of claim 1, wherein said temperature difference between said first-set-point and said second-set-point is less than 10-degrees Fahrenheit.

11. The temperature control system of claim 1, wherein said temperature difference between said first-set-point and said second-set-point is greater than 10-degrees Fahrenheit.

12. The temperature control system of claim 1, wherein said first set point is 34-degree Fahrenheit.

13. The temperature control system of claim 1, wherein said second set-point is 23-degrees Fahrenheit.

14. The temperature control system of claim 1, wherein said alternating current power supply includes 120 volts.

15. The temperature control system of claim 1, wherein said alternating current power supply includes 240 volts.

16. The temperature control system of claim 1, wherein said alternating current power supply includes 480 volts.

17. A temperature control system, the system comprising:
an electrical relay assembly, said electrical relay system including a relay-coil and a relay including at least two poles, said relay controllable via said relay-coil;
a thermistor located in proximity to cooling fins of a refrigeration system, said thermistor being ¼-inch in nominal size, said thermistor located on the exit side of said cooling fins of said evaporative refrigeration system;
a normally open/normally closed digital thermostat;
a parallel-circuit electrically coupled to said relay and said evaporative cooling system;
a series-circuit electrically coupled to said evaporative cooling system;
wherein said system is electrically coupled to an alternating current power supply;
wherein said relay-coil is in electrical communication and controlled via said thermostat;
wherein said thermostat is in electrical communication with said thermistor;
wherein said relay operates in a normally closed position when said thermistor reads a temperature above a first-set-point;
wherein said relay operates in an open position when said thermistor reads a temperature at or below a second-set-point;
wherein said temperature control system is configured to operate both said parallel-circuit and said series-circuit while said temperature is above said first-set-point;
wherein said temperature control system, via said relay assembly, cuts current flow to said parallel-circuit when said temperature is at or below said second-set-point configured to reduce a wattage supplied and therefore a speed of fan motors of said evaporative refrigeration system;
wherein said thermistor is located on the exit-side of said cooling fins of said refrigeration system;
wherein said thermistor is located vertically in the center of said cooling fins and substantially 1-inch horizontally from a bottom of said cooling fins of said refrigeration system;
wherein said refrigeration system includes three fan motors;
wherein said thermistor and said thermostat control operation of a condenser and therefore turn off said condenser when said temperature is at or below said second-set-point;
wherein said thermistor and said thermostat control operation of a condenser and therefore turn on said condenser when said temperature is above said first-set-point;
wherein said temperature difference between said first-set-point and said second-set-point is less than 10-degrees Fahrenheit; and
wherein said alternating current power supply includes 120 volts.

18. The temperature control system of claim 17, further comprising set of instructions; and
wherein said temperature control system is arranged as a kit.

19. A method of using a temperature control system, the method comprising the steps of:
providing a refrigeration system;
providing a temperature control system; and
placing a thermistor of said temperature control system in proximity to cooling fins of said refrigeration system.

20. The method of claim 19, further comprising the steps of:
providing electrical power supply in both a series arrangement and a parallel arrangement to fan motors of said refrigeration system when said thermistor reads a first temperature; and
commencing providing electrical power to the parallel arrangement to said fan motors of said refrigeration system when said thermistor reads a second temperature.
